(19) United States
(12) Patent Application Publication
(10) Pub. No.: US 2024/0283344 A1
(43) Pub. Date: Aug. 22, 2024

(54) VIBRATION MOTOR

(71) Applicant: Nidec Corporation, Kyoto (JP)

(72) Inventors: Ryoichi MITSUHATA, Kyoto (JP); Jun INOUE, Kyoto (JP)

(21) Appl. No.: 18/581,492

(22) Filed: Feb. 20, 2024

(30) Foreign Application Priority Data
Feb. 22, 2023 (JP) 2023-025962

(51) Int. Cl. H02K 33/02; H02K 3/28; H02K 5/15

(52) U.S. Cl. CPC H02K 33/02; H02K 3/28; H02K 5/15; H02K 2203/03; H02K 2203/06

(57) ABSTRACT

A vibration motor includes a movable portion and a stationary portion including a housing with a housing cylindrical portion, a housing lid at an end of the housing cylindrical portion, and adhesive. The housing lid includes a lid body portion covering an opening on one side of the housing cylindrical portion, and a lid fixing portion protruding from the lid body portion to another side and inside the housing cylindrical portion. The adhesive is in at least a portion of a bonding region between the housing cylindrical portion and the lid fixing portion in a radial direction. The housing cylindrical portion includes a cutout portion recessed from an end surface on one side of the housing cylindrical portion to the other side and penetrating the housing cylindrical portion in the radial direction. A portion of the bonding region is exposed to an outside of the housing through the cutout portion.

### CROSS-REFERENCE TO RELATED APPLICATIONS

The present application claims priority under 35 U.S.C. § 119 to Japanese Patent Application No. 2023-025962, filed on Feb. 22, 2023, the entire contents of which are hereby incorporated herein by reference.

### 1. FIELD OF THE INVENTION

The present disclosure relates to a vibration motor.

### 2. BACKGROUND

A conventional vibration motor includes a movable body capable of vibrating in an axial direction. The movable body is disposed inside the cylindrical body. The axial opening of the cylindrical body is covered by the upper case and the lower case.

For example, the case (upper case or lower case) is fixed to the cylindrical body via an adhesive. The adhesive is disposed in a region between the cylindrical body and the case in a radial direction. In this configuration, in the manufacturing process of fixing the cylindrical body and the case with the adhesive, if the adhesive leaks from the region between the cylindrical body and the case in the radial direction, the amount of the adhesive becomes insufficient, and the case may be easily detached from the cylindrical body. In other words, the strength of the vibration motor may decrease. In addition, when the adhesive leaks from the case and is hardened as it is, the dimension of the vibration motor increases or the appearance of the vibration motor deteriorates.

### SUMMARY

A vibration motor according to an example embodiment of the present disclosure includes a stationary portion and a movable portion capable of vibrating in an axial direction along a center axis with respect to the stationary portion. The stationary portion includes a housing. The housing has a cylindrical shape extending in the axial direction along the center axis, and includes a housing cylindrical portion in which the movable portion is located, a housing lid located at an end on one side in the axial direction of the housing cylindrical portion, and an adhesive. The housing lid includes a lid body portion that covers an opening on one side in the axial direction of the housing cylindrical portion, and a lid fixing portion that protrudes from the lid body portion to another side in the axial direction and is located inside the housing cylindrical portion. The adhesive is located in at least a portion of a bonding region which is a region between the housing cylindrical portion and the lid fixing portion in a radial direction. The housing cylindrical portion includes a cutout portion which is recessed from an end surface on one side in the axial direction of the housing cylindrical portion to the other side in the axial direction and penetrates in the radial direction. A portion of the bonding region is exposed to an outside of the housing through the cutout portion.

A vibration motor according to an example embodiment of the present disclosure includes a stationary portion and a movable portion capable of vibrating in an axial direction along a center axis with respect to the stationary portion. The stationary portion includes a housing. The housing has a cylindrical shape extending in the axial direction along the center axis, and includes a housing cylindrical portion in which the movable portion is located, a housing lid located at an end on one side in the axial direction of the housing cylindrical portion, and an adhesive. The housing lid includes a lid body portion that covers an opening on one side in the axial direction of the housing cylindrical portion, and a lid fixing portion that protrudes from the lid body portion to another side in the axial direction and is located inside the housing cylindrical portion. The adhesive is located in at least a portion of a bonding region which is a region between the housing cylindrical portion and the lid fixing portion in a radial direction. The housing lid includes a cutout portion that is recessed in the radially inner side from the radially outer surface of the housing lid, penetrates the lid body portion in the axial direction from an end surface on one side in the axial direction of the housing lid, and reaches the lid fixing portion. A portion of the bonding region is exposed to an outside of the housing through the cutout portion.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view of a vibration motor according to a first example embodiment of the present invention.

FIG. 2 is a cross-sectional view of the vibration motor according to the first example embodiment.

FIG. 3 is an exploded perspective view of a housing according to the first example embodiment.

FIG. 4 is a perspective view of the housing according to the first example embodiment.

FIG. 5 is an enlarged cross-sectional view of an upper end portion of the housing according to the first example embodiment.

FIG. 6 is a cross-sectional perspective view of the upper end portion of the housing according to the first example embodiment.

FIG. 7 is a plan view of the housing according to the first example embodiment as viewed from a radial direction.

FIG. 8 is a schematic view in a case where there is a concave portion on a radially outer surface of a lid fixing portion of the housing according to the first example embodiment.

FIG. 9 is a perspective view of the lid fixing portion (a lid fixing portion having an adhesive groove portion) of the housing according to the first example embodiment.

FIG. 10 is an exploded perspective view of the vibration motor according to the first example embodiment.

FIG. 11 is a perspective view in which a circuit board and a sealing portion are omitted from the vibration motor according to the first example embodiment.

FIG. 12 is a plan view of the vibration motor according to the first example embodiment as viewed from below.

FIG. 13 is a perspective view of a bearing according to the first example embodiment.

FIG. 14 is an exploded perspective view of a housing according to a second example embodiment of the present invention.

FIG. 15 is a perspective view of the housing according to the second example embodiment.

FIG. 16 is a plan view of the housing according to the second example embodiment as viewed from above.

### DETAILED DESCRIPTION

Example embodiments of the present disclosure will be described below with reference to the accompanying drawings.

In the present specification, a direction in which a center axis CA of a vibration motor 1000 extends is referred to as an “axial direction”, and a circumferential direction around the center axis CA is referred to as a “circumferential direction”.

In the present specification, the axial direction is defined as the vertical direction. Further, one axial direction is defined as upward, and the other axial direction is defined as downward. That is, the upper side in the specification corresponds to “one side in the axial direction”, and the lower side corresponds to “the other side in the axial direction”. In the present specification, the side on which a housing lid 12 is disposed is the upper side, and the side on which a bearing lid 22 is disposed is the lower side. However, the definition of the vertical direction does not limit the actual orientation and positional relationship of each component of the vibration motor 1000.

In the present specification, in each component, the end on the upper side (that is, the end on one side in the axial direction) is referred to as an “upper end portion”, and the end on the lower side (that is, the end on the other side in the axial direction) is referred to as a “lower end portion”. Further, in each component, an end surface facing upward (that is, the end surface on one side in the axial direction) of the upper end portion is referred to as an “upper end surface”, and an end surface facing downward (that is, the end surface on the other side in the axial direction) is referred to as a “lower end surface”.

In the present specification, a direction orthogonal to the center axis CA is referred to as a “radial direction”. In the radial direction, an orientation approaching the center axis CA is referred to as “radially inner side”, and an orientation separating from the center axis CA is referred to as “radially outer side”. Further, in each component, a side surface facing the radially inner side is referred to as a “radially inner surface”, and a side surface facing the radially outer side is referred to as a “radially outer surface”.

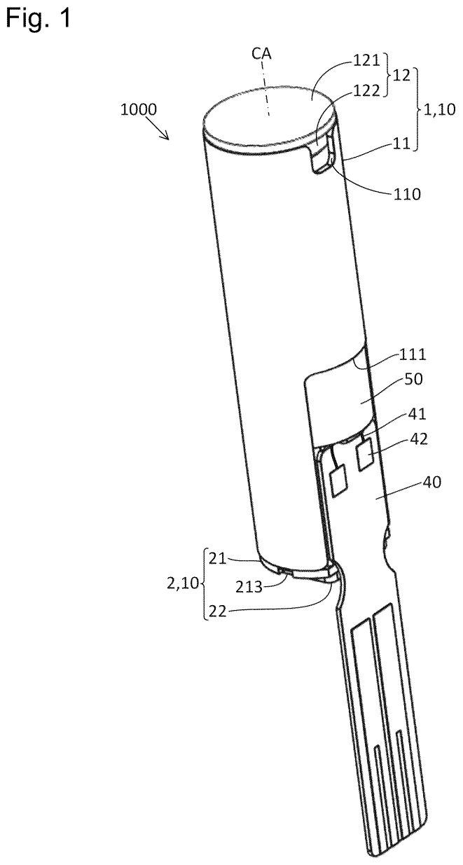

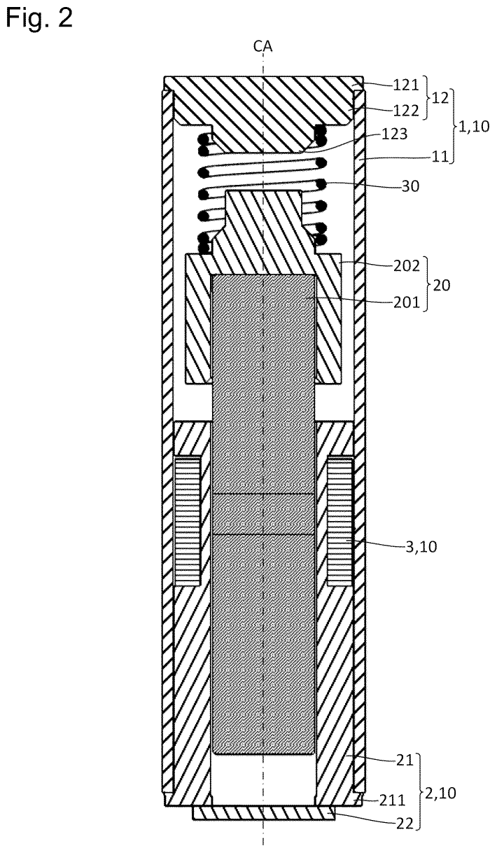

FIG. 1 is a perspective view of the vibration motor 1000 according to a first example embodiment. FIG. 2 is a cross-sectional view of the vibration motor 1000 according to the first example embodiment. FIG. 2 corresponds to a cross section of the vibration motor 1000 taken along a plane including the center axis CA.

The vibration motor 1000 includes a stationary portion 10 and a movable portion 20. The movable portion 20 can vibrate in the axial direction along the center axis CA with respect to the stationary portion 10. In other words, the stationary portion 10 supports the movable portion 20 so as to be able to vibrate in the axial direction along the center axis CA.

The vibration motor 1000 includes an elastic member 30. The elastic member 30 is, for example, a coil spring. The elastic member 30 may be, for example, a leaf spring or a cushion. The elastic member 30 connects the stationary portion 10 and the movable portion 20. The details will be described later.

The vibration motor 1000 includes a circuit board 40. The circuit board 40 is, for example, a flexible printed circuit (FPC). The circuit board 40 may be, for example, a non-soft one (for example, a hard substrate) such as a flexible printed circuit board. The circuit board 40 is electrically connected to a coil 3. The circuit board 40 has a circuit for controlling energization to the coil 3.

The stationary portion 10 includes a housing 1. The housing 1 is made of a non-magnetic material. The housing 1 is made of, for example, stainless steel, but may be made of an alloy or the like. The housing 1 has a covered cylindrical shape. The housing 1 has its internal space as an accommodation region. The housing 1 accommodates the movable portion 20 therein. That is, the movable portion 20 is disposed inside the housing 1.

The housing 1 has a housing cylindrical portion 11. The housing cylindrical portion 11 is a cylindrical body extending in the axial direction along the center axis CA. Specifically, the housing cylindrical portion 11 has a cylindrical shape extending in the axial direction along the center axis CA. The movable portion 20 is disposed inside the housing cylindrical portion 11. That is, the housing cylindrical portion 11 covers the movable portion 20 from the radially outer side.

The housing 1 includes the housing lid 12. The housing 12 is disposed at the upper end portion of the housing cylindrical portion 11. The housing lid 12 includes a lid body portion 121 and a lid fixing portion 122. The lid body portion 121 has a disk shape centered on the center axis CA. The lid body portion 121 covers an upper opening of the housing cylindrical portion 11. In a state where the upper opening of the housing cylindrical portion 11 is covered with the lid body portion 121, the radially outer end of the lid body portion 121 contacts the upper end surface of the housing cylindrical portion 11. The stationary portion 10 includes a bearing 2. The bearing 2 is made of resin, but is not limited thereto, and may be made of metal. However, when the bearing 2 is made of metal, insulation cannot be achieved with the coil 3 to be described later, and thus it is necessary to interpose an insulating material in a portion of the bearing 2 around which the coil 3 is wound. On the other hand, when the bearing 2 is made of resin, the coil 3 can be directly wound around the bearing 2 without interposing an insulating material. The bearing 2 is a sleeve bearing. The bearing 2 supports a core portion 201 described later so as to be able to vibrate in the axial direction along the center axis CA.

The bearing 2 has a bearing cylindrical portion 21. The bearing cylindrical portion 21 functions as a sleeve bearing. The bearing cylindrical portion 21 has a cylindrical shape extending in the axial direction along the center axis CA. The bearing cylindrical portion 21 is disposed inside the housing cylindrical portion 11. At least a part of the core portion 201 to be described later is inserted into the bearing cylindrical portion 21. For example, more than a half of the core portion 201 is inserted into the bearing cylindrical portion 21. Accordingly, the bearing cylindrical portion 21 can stably hold the core portion 201.

The bearing cylindrical portion 21 has a bearing collar portion 211. Specifically, the lower end portion of the bearing cylindrical portion 21 protrudes downward from the housing cylindrical portion 11. The bearing collar portion 211 protrudes to the radially outer side from the lower end portion of the bearing cylindrical portion 21 over the entire circumference of the bearing cylindrical portion 21. The radially outer tip of the bearing collar portion 211 is disposed on the radially inner side of the radially outer surface of the housing cylindrical portion 11. Alternatively, the radially outer tip of the bearing collar portion 211 is disposed at a position flush with the radially outer surface of the housing cylindrical portion 11. The upper end surface of the bearing collar portion 211 is in contact with the lower end surface of the housing cylindrical portion 11. As a result, the bearing 2 is positioned in the axial direction. The lower end surface of the bearing cylindrical portion 21 also includes the lower end surface of the bearing collar portion 211.

The bearing 2 has a bearing lid 22. A constituent material of the bearing lid 22 is not particularly limited, and may be made of metal or resin. The bearing lid 22 is disposed at the lower end portion of the bearing cylindrical portion 21. The bearing lid 22 is adhered to the lower end surface of the bearing cylindrical portion 21. Thus, the bearing lid 22 covers the lower opening of the bearing cylindrical portion 21. Since the lower opening of the bearing cylindrical portion 21 is covered, it is possible to suppress entry of foreign matter such as dust from the outside to the inside of the vibration motor 1000. For example, the bearing lid 22 is a resin seal. A seal as the bearing lid 22 is attached to the lower end surface of the bearing cylindrical portion 21.

The stationary portion 10 includes the coil 3. The coil 3 applies a driving force to the movable portion 20 (a core portion 201 to be described later). The coil 3 is formed by winding a conductive wire around the outer peripheral surface of the bearing cylindrical portion 21. Accordingly, the coil 3 is disposed inside the housing cylindrical portion 11. For example, the bearing cylindrical portion 21 has a groove portion (reference numeral is omitted) continuously extending in the circumferential direction and making one turn on the radially outer surface. The coil 3 is disposed in the groove portion on the radially outer surface of the bearing cylindrical portion 21. Since the coil 3 is disposed in the groove portion on the radially outer surface of the bearing cylindrical portion 21, the vibration motor 1000 can be downsized in the radial direction.

The movable portion 20 includes a core portion 201. The core portion 201 extends along the center axis CA in the axial direction. The core portion 201 has a cylindrical columnar shape extending in the axial direction. However, the shape of the core portion 201 is not limited to the columnar shape. The core portion 201 is inserted into the bearing 2 from the upper side to the lower side. The core portion 201 is held in a state where the lower end portion thereof is inserted into at least the bearing 2. That is, the core portion 201 is disposed on the radially inner side of the coil 3.

For example, although reference numerals are omitted, the core portion 201 includes a magnetic body and a pair of magnets sandwiching the magnetic body in the axial direction. In the upper magnet, a lower side is an S pole, and an upper side is an N pole. In the lower magnet, an upper side is an S pole, and a lower side is an N pole. In this case, the S poles face each other in the axial direction with the magnetic body interposed therebetween. Alternatively, in the upper magnet, the lower side is the N pole, and the upper side is the S pole. In the lower magnet, the upper side is an N pole, and the lower side is an S pole. In this case, the N poles face each other in the axial direction with the magnetic body interposed therebetween.

The movable portion 20 includes a holder 202. The holder 202 is disposed at the upper end portion of the core portion 201. For example, the holder 202 has a concave portion (reference sign is omitted) recessed upward from below. The upper end portion of the core portion 201 is fitted into the concave portion of the holder 202 and is fixed to the holder 202. The holder 202 vibrates in the axial direction together with the core portion 201. The holder 202 functions as a weight. The constituent material of the holder 202 is, for example, stainless steel, but may be tungsten heavier than stainless steel. Stainless steel is easier to process than tungsten.

The elastic member 30 is disposed between the housing lid 12 and the holder 202 in the axial direction. The upper end portion of the elastic member 30 is fixed to the lower end portion (a convex portion 123 to be described later) of the housing lid 12 with an adhesive. The lower end portion of the elastic member 30 is fixed to the upper end portion of the holder 202 with an adhesive. The elastic member 30 biases the movable portion 20 downward. Note that a method of fixing the elastic member 30 to the housing lid 12 and the holder 202 is not particularly limited. For example, the upper end portion of the elastic member 30 may be welded to the lower end portion of the housing lid 12. The lower end portion of the elastic member 30 may be welded to the upper end portion of the holder 202.

At least a part of the circuit board 40 is fixed to the stationary portion 10 with an adhesive. Note that a method of fixing the circuit board 40 to the stationary portion 10 is not particularly limited. For example, at least a part of the circuit board 40 may be welded to the stationary portion 10. The arrangement position of the circuit board 40 will be described in detail later. The circuit board 40 is connected to the coil 3 via a lead wire 41. That is, the vibration motor 1000 includes the lead wire 41 that connects the coil 3 and the circuit board 40. The coil 3 is energized from the circuit board 40 via the lead wire 41.

When the coil 3 is energized, a magnetic field is generated from the coil 3. Then, the movable portion 20 vibrates in the axial direction by the interaction between the magnetic field generated from the coil 3 and the magnetic field by the core portion 201.

The vibration motor 1000 includes a sealing portion 50. The sealing portion 50 is a cured resin. The constituent material of the sealing portion 50 is higher in viscosity than the constituent material of an adhesive 13 described later. Although details will be described later, a connection portion between the coil 3 and the lead wire 41 is not covered with the housing 1. Therefore, a connection portion between the coil 3 and the lead wire 41 is sealed by the sealing portion 50. In other words, the sealing portion 50 covers at least the connection portion between the coil 3 and the lead wire 41 from the radially outer side. On the other hand, in order to facilitate connection between the circuit board 40 and the lead wire 41, a connection portion between the circuit board 40 and the lead wire 41 is exposed. This facilitates connection between the circuit board 40 and the lead wire 41 even after the constituent material of the sealing portion 50 is applied at the time of assembling the vibration motor 1000.

In the configuration in which at least a part of the coil 3 is covered with the sealing portion 50, when the viscosity of the constituent material of the sealing portion 50 is low, there is a possibility that the constituent material of the sealing portion 50 penetrates into the gap of the conductive wire of the coil 3, or the constituent material of the sealing portion 50 adheres to an unnecessary portion to deteriorate the appearance. Therefore, the constituent material of the sealing portion 50 is preferably higher in viscosity than the constituent material of the adhesive 13.

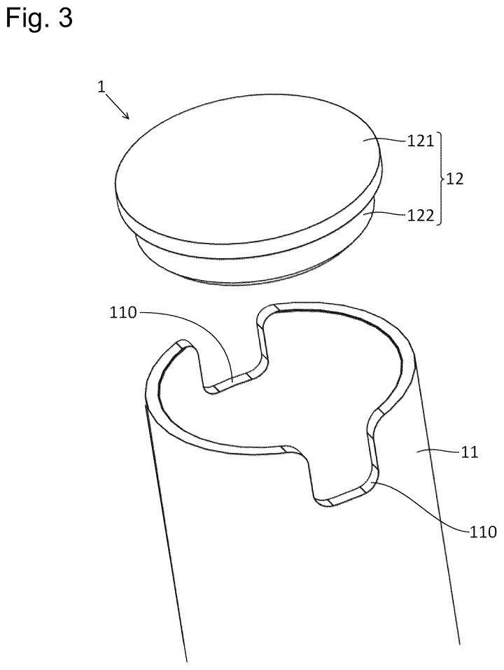

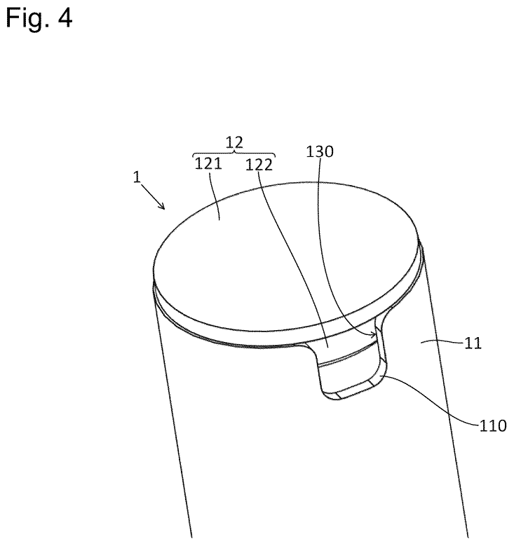

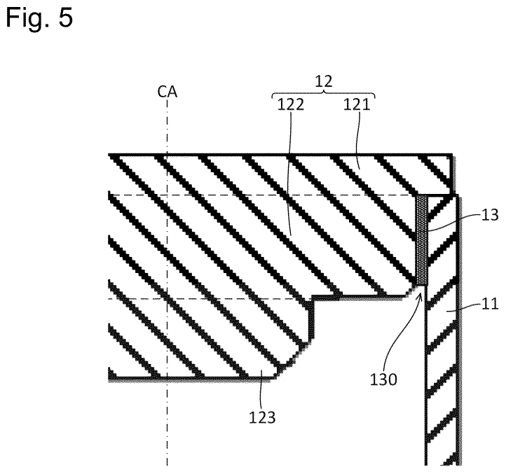

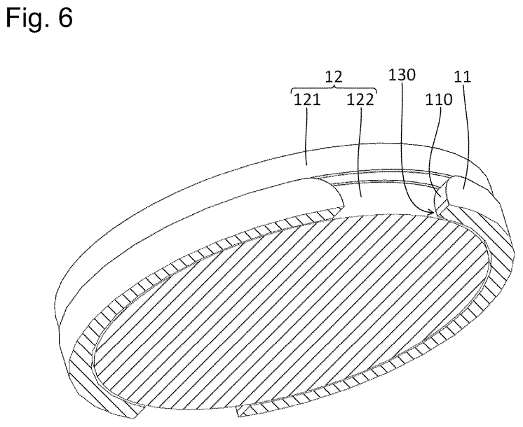

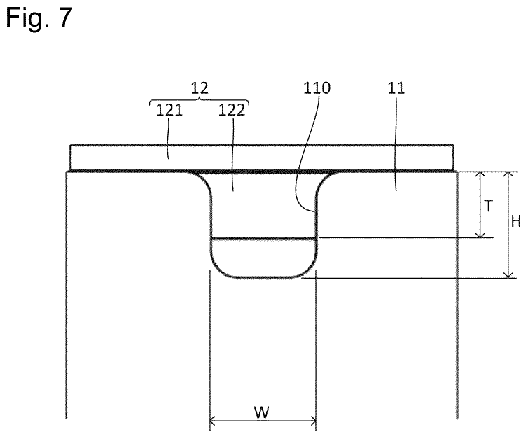

FIG. 3 is an exploded perspective view of the housing 1 according to the first example embodiment, and FIG. 4 is a perspective view of the housing 1 according to the first example embodiment. In other words, FIG. 3 is a view illustrating a state before the housing lid 12 is fixed to the housing cylindrical portion 11, and FIG. 4 is a view illustrating a state after the housing lid 12 is fixed to the housing cylindrical portion 11. In FIGS. 3 and 4, only the periphery of the upper end portion of the housing 1 is illustrated. FIG. 5 is an enlarged cross-sectional view of an upper end portion of the housing 1 according to the first example embodiment. FIG. 5 corresponds to a cross section obtained by cutting the upper end portion of the housing 1 along a plane including the center axis CA. FIG. 6 is a cross-sectional perspective view of the upper end portion of the housing 1 according to the first example embodiment. FIG. 6 corresponds to a cross section obtained by cutting the upper end portion of the housing 1 along a plane orthogonal to the center axis CA. FIG. 7 is a plan view of the housing 1 according to the first example embodiment as viewed from a radial direction.

The adhesive 13 is used to fix the housing cylindrical portion 11 and the housing lid 12. That is, the housing 1 includes the adhesive 13. The type of the adhesive 13 is not particularly limited. For example, an epoxy adhesive and an acrylic adhesive can be used. The constituent material of the adhesive 13 is lower in viscosity than the constituent material of the sealing portion 50. In a case where the viscosity of the adhesive 13 is high, when the adhesive 13 is filled in the gap between the housing cylindrical portion 11 and the housing lid 12 in the radial direction, the adhesive 13 may be difficult to reach in the circumferential direction. Therefore, the constituent material of the adhesive 13 is preferably lower in viscosity than the constituent material of the sealing portion 50. As a result, when the adhesive 13 is filled in the gap between the housing cylindrical portion 11 and the housing lid 12 in the radial direction, the adhesive 13 easily goes in the circumferential direction, so that the housing cylindrical portion 11 and the housing lid 12 can be firmly fixed. However, the constituent material of the adhesive 13 and the constituent material of the sealing portion 50 may be the same.

A part of the housing lid 12 is fitted into the housing cylindrical portion 11 and is fixed by the adhesive 13. Specifically, the lid fixing portion 122 protrudes downward from the lid body portion 121 and is disposed inside the housing cylindrical portion 11. The lid fixing portion 122 has a columnar shape and protrudes in the axial direction along the center axis CA. The adhesive 13 is disposed in at least a part of a bonding region 130 which is a region between the housing cylindrical portion 11 and the lid fixing portion 122 in the radial direction.

The lid fixing portion 122 has a convex portion 123 protruding downward on the lower end surface (see FIGS. 2 and 5). The convex portion 123 has a columnar shape and protrudes in the axial direction along the center axis CA. The upper end portion of the elastic member 30 is fixed to the convex portion 123. The axial length of the lid fixing portion 122 may be half or less of the axial length of the elastic member 30. In FIG. 5, a boundary between the lid body portion 121 and the lid fixing portion 122 is indicated by a broken line for convenience. Further, a boundary between the lid fixing portion 122 and the convex portion 123 is indicated by a broken line.

For example, although not illustrated, the lid fixing portion 122 may have a groove portion that is centered on the center axis CA and is annularly recessed upward. The upper end portion of the elastic member 30 may be disposed in an annular groove portion of the lid fixing portion 122. Similarly, the holder 202 may have a groove portion centered on the center axis CA and recessed downward in an annular shape. The lower end portion of the elastic member 30 may be disposed in the groove portion of the holder 202.

Here, in the assembly process of the housing 1 (that is, the step of fixing the housing lid 12 to the housing cylindrical portion 11), the adhesive 13 is injected into the bonding region 130 in a state where the lid fixing portion 122 is disposed inside the housing cylindrical portion 11. Therefore, the housing cylindrical portion 11 has an injection port for the adhesive 13.

Specifically, in the first example embodiment, the housing cylindrical portion 11 has a cutout portion 110. The cutout portion 110 serves as an injection port of the adhesive 13. The cutout portion 110 is recessed downward from the upper end surface of the housing cylindrical portion 11 and penetrates in the radial direction. As a result, a part of the bonding region 130 is exposed to the radially outer side from the housing cylindrical portion 11 via the cutout portion 110. In other words, a part of the lid fixing portion 122 is exposed from the housing cylindrical portion 11 via the cutout portion 110. In other words, a part of the bonding region 130 is exposed to the outside of the housing 1 via the cutout portion 110. As a result, a part of the bonding region 130 is visible from the outside of the housing 1. As a result, the adhesive 13 can be easily applied with the dispenser needle as described later.

When the housing cylindrical portion 11 has the cutout portion 110, in the assembly process of the housing 1, the adhesive 13 can be injected into the bonding region 130 in a state where the lid fixing portion 122 is disposed inside the housing cylindrical portion 11. Specifically, in the assembly process of the housing 1, first, the lid fixing portion 122 is fitted into the housing cylindrical portion 11. Here, even when the lid fixing portion 122 is fitted into the housing cylindrical portion 11, a part of the bonding region 130 is exposed from the cutout portion 110. Thereafter, although not illustrated, the tip of the dispenser needle (that is, the discharge port) is disposed in the cutout portion 110, and the adhesive 13 is discharged from the dispenser needle. At this time, the adhesive 13 enters the bonding region 130 exposed from the cutout portion 110, and the adhesive 13 flows in the circumferential direction. As a result, substantially the entire area of the bonding region 130 is filled with the adhesive 13. That is, the housing lid 12 is fixed to the housing cylindrical portion 11 via the adhesive 13.

For example, when the cutout portion 110 does not exist in the housing cylindrical portion 11, after the adhesive 13 is applied to the radially outer surface of the lid fixing portion 122 (alternatively, after the adhesive 13 is applied to the radially inner surface of the housing cylindrical portion 11), an operation of fitting the lid fixing portion 122 into the housing cylindrical portion 11 is performed. In this case, when the lid fixing portion 122 is fitted into the housing cylindrical portion 11, the adhesive 13 is easily filtered from the bonding region 130 by the upper end portion of the housing cylindrical portion 11 and leaks to the outside, so that the amount of the adhesive 13 disposed in the bonding region 130 is reduced. In addition, when the leakage of the adhesive 13 from the bonding region 130 increases, the wiping operation of the adhesive 13 needs to be performed. In order to omit the wiping operation of the adhesive 13, the amount of the adhesive 13 used may be reduced to suppress the leakage of the adhesive 13, but the amount of the adhesive 13 disposed in the bonding region 130 is reduced. As a result, when the cutout portion 110 does not exist in the housing cylindrical portion 11, the fixing of the housing lid 12 to the housing cylindrical portion 11 is weakened, and the strength of the housing 1 may be reduced. In other words, the housing lid 12 may be detached from the housing cylindrical portion 11. In addition, in a case where the adhesive 13 leaks from the housing 1 and is hardened as it is, the dimension of the vibration motor 1000 may increase, or the appearance of the vibration motor 1000 may deteriorate.

On the other hand, in the first example embodiment, the adhesive 13 can be injected into the bonding region 130 by the dispenser needle in a state where the lid fixing portion 122 is disposed inside the housing cylindrical portion 11. As a result, it is possible to suppress the adhesive 13 from leaking from the bonding region 130 by discharging an appropriate amount of the adhesive 13 from the dispenser needle disposed in the cutout portion 110. That is, the bonding region 130 can be filled with an appropriate amount of the adhesive 13. An appropriate amount of the adhesive 13 is an amount in which the adhesive 13 does not substantially leak from the bonding region 130, and is an amount sufficient for fixing the housing lid 12 to the housing cylindrical 13 is portion 11. The appropriate amount of the adhesive determined experimentally and empirically.

Thus, in the first example embodiment, the housing lid 12 can be firmly fixed to the housing cylindrical portion 11. As a result, it is possible to suppress a decrease in strength of the housing 1. That is, it is possible to suppress a decrease in strength of the vibration motor 1000. In the assembly process of the housing 1, the wiping operation of the adhesive 13 can be omitted. Furthermore, since leakage of the adhesive 13 to the outside of the housing 1 is suppressed, it is possible to suppress an increase in size of the vibration motor 1000 and deterioration in appearance.

In the first example embodiment, the radially inner surface of the lid fixing portion 122 extends continuously in the circumferential direction along the radially inner surface of the housing cylindrical portion 11 (see FIG. 6). That is, on the radially outer surface of the lid fixing portion 122, there is no step such as a concave portion over the entire circumference in the circumferential direction. As a result, substantially the entire portion of the radially outer surface of the lid fixing portion 122 that does not overlap the cutout portion 110 in the radial direction can be adhered to the radially inner surface of the housing cylindrical portion 11. When the bonding region 130 is filled with the adhesive 13, the adhesive 13 easily flows in a region between the housing cylindrical portion 11 and the housing lid 12 in the radial direction. In FIG. 6, illustration of the adhesive 13 is omitted.

In the first example embodiment, the axial thickness T of the lid fixing portion 122 is equal to or more than a half of the cutting depth H of the cutout portion 110 in the axial direction (see FIG. 7). As a result, since the bonding region 130 becomes large in the axial direction, it is easy to fill the bonding region 130 with the adhesive 13. In addition, since the amount of the adhesive 13 used can be increased, the fixing of the housing lid 12 to the housing cylindrical portion 11 becomes stronger.

In the first example embodiment, the thickness T of the lid fixing portion 122 is equal to or more than a half of the cutting depth H and smaller than the cutting depth H. Therefore, when viewed from the radial direction, a gap is generated between the lower end surface of the lid fixing portion 122 and the bottom surface of the cutout portion 110 in the axial direction. However, the present disclosure is not limited to this.

The thickness T of the lid fixing portion 122 in the axial direction may be equal to or larger than the cutting depth H of the cutout portion 110 in the axial direction. In this case, although not illustrated, the lid fixing portion 122 closes the entire cutout portion 110 when viewed from the radial direction. That is, when viewed from the radial direction, no gap is generated between the lower end surface of the lid fixing portion 122 and the bottom surface of the cutout portion 110 in the axial direction. This makes it possible to suppress foreign matters from entering the housing 1.

In the first example embodiment, the opening width W in the circumferential direction of the cutout portion 110 is equal to or less than a half of the length in the circumferential direction of the housing cylindrical portion 11 (see FIG. 7). As a result, it is possible to suppress insufficiency of the bonding region 130 due to the excessively large cutout portion 110.

For example, the size of the opening of the cutout portion 110 as viewed from the radial direction is set based on the diameter of the tip of the dispenser needle used in the assembly process of the housing 1. The opening of the cutout portion 110 as viewed from the radial direction is set to a size in which at least the tip of the dispenser needle can be disposed. The opening of the cutout portion 110 as viewed from the radial direction is preferably smaller as long as the tip of the dispenser needle can be disposed.

The opening shape of the cutout portion 110 as viewed from the radial direction is a substantially rectangular shape. However, the opening shape of the cutout portion 110 as viewed from the radial direction is not particularly limited, and may be a circular shape, a semicircular shape, a polygonal shape, or the like.

The number of cutout portions 110 is not particularly limited. One or a plurality of cutout portions 110 may be provided. For example, there are two cutout portions 110, and they face each other in the radial direction with the center axis CA interposed therebetween when viewed from the axial direction. As a result, the adhesive 13 can be injected from a plurality of places into the bonding region 130.

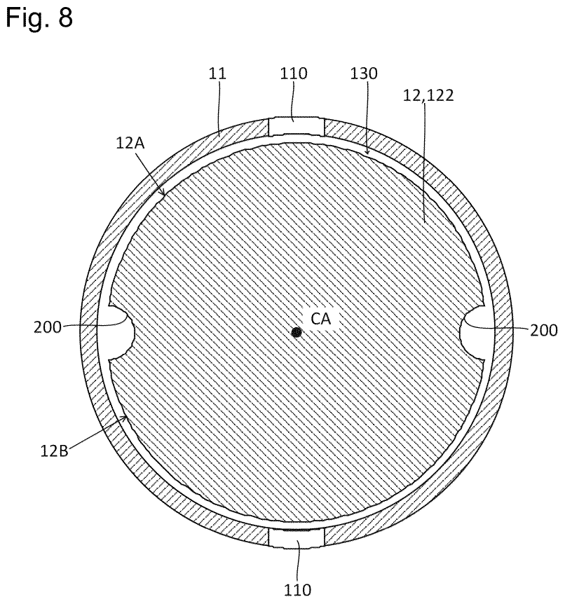

When a plurality of concave portions (steps) are present on the radially outer surface of the lid fixing portion 122, it is preferable to provide a plurality of cutout portions 110 in the housing cylindrical portion 11. For example, as illustrated in FIG. 8, when two concave portions 200 extending in the axial direction exist on the radially outer surface of the lid fixing portion 122, the radially outer surface of the lid fixing portion 122 is divided into two when viewed from the axial direction.

Note that FIG. 8 is a schematic view in a case where the concave portion 200 is provided on the radially outer surface of the lid fixing portion 122 of the housing 1 according to the first example embodiment. FIG. 8 corresponds to a cross section when the upper end portion of the housing 1 is cut along a plane orthogonal to the center axis CA and viewed from above. Here, for convenience, one of the radially outer surfaces divided into two of the lid fixing portions 122 is referred to as one lid outer surface 12A, and the other is referred to as the other lid outer surface 12B.

When the two concave portions 200 are present on the radially outer surface of the lid fixing portion 122 as described above, it is preferable that the housing cylindrical portion 11 be provided with the two cutout portions 110, one cutout portion 110 be overlapped with the one lid outer surface 12A in the radial direction, and the other cutout portion 110 be overlapped with the other lid outer surface 12B in the radial direction. As a result, by injecting the adhesive 13 from the one cutout portion 110, the adhesive 13 is easily filled in the bonding region 130 constituted by the radially inner surface of the housing cylindrical portion 11 and the one lid outer surface 12A. In addition, by injecting the adhesive 13 from the other cutout portion 110, the adhesive 13 is easily filled in the bonding region 130 configured by the radially inner surface of the housing cylindrical portion 11 and the other lid outer surface 12B. As a result, the adhesive 13 can be filled over substantially the entire circumference.

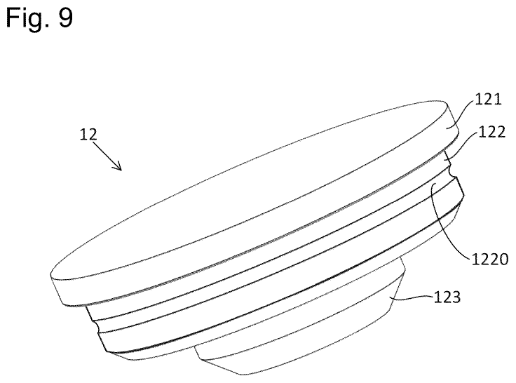

As illustrated in FIG. 9, the radially outer surface of the lid fixing portion 122 may have an adhesive groove portion 1220. The adhesive groove portion 1220 is recessed to the radially inner side and extends in the circumferential direction. For example, the adhesive groove portion 1220 continuously extends in the circumferential direction and makes one turn. That is, the adhesive groove portion 1220 has a continuous annular shape without being interrupted in the circumferential direction. As a result, the fluidity of the adhesive 13 injected into the bonding region 130 in the circumferential direction is improved.

In the example embodiment shown in FIG. 9, the number of adhesive groove portions 1220 is one, but the number of adhesive groove portions 1220 is not particularly limited. For example, a plurality of adhesive groove portions 1220 may be arranged at intervals in the axial direction. Further, the adhesive groove portion 1220 may not extend continuously in the circumferential direction, and may be divided into a plurality of portions in the circumferential direction. In other words, the adhesive groove portions 1220 shorter than the circumferential length of the lid fixing portion 122 arranged at may be intervals in the circumferential direction.

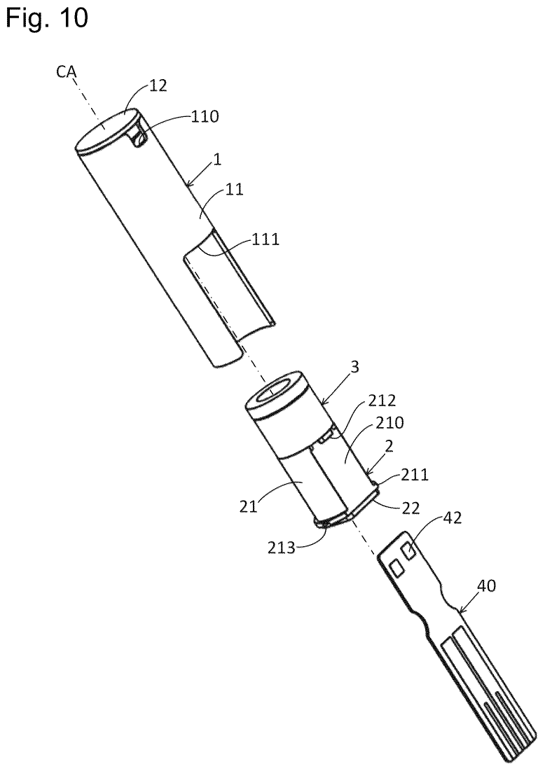

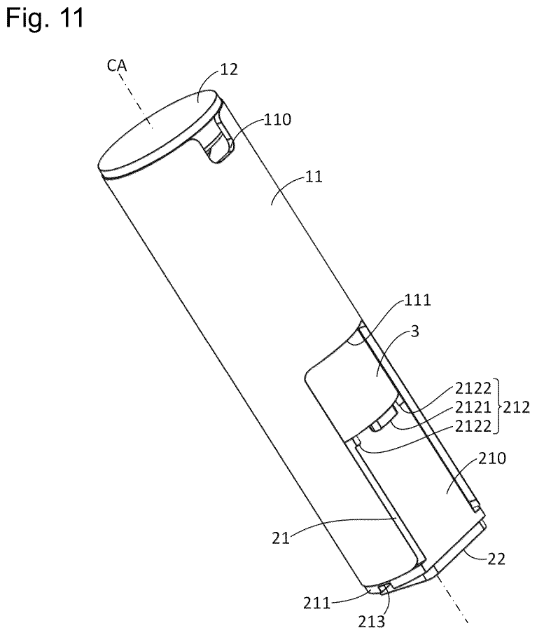

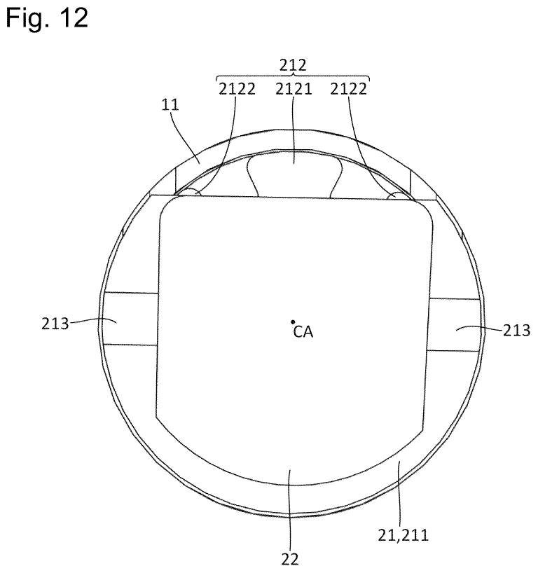

FIG. 10 is an exploded perspective view of a part of the vibration motor 1000 according to the first example embodiment. In FIG. 10, illustration of the movable portion 20 is omitted. FIG. 11 is a perspective view in which the circuit board 40 and the sealing portion 50 are omitted from the vibration motor 1000 according to the first example embodiment. FIG. 12 is a plan view of the vibration motor 1000 according to the first example embodiment as viewed from below. In FIG. 12, illustration of the circuit board 40 is omitted.

The circuit board 40 is fixed to the radially outer surface of the bearing cylindrical portion 21. Therefore, the housing cylindrical portion 11 has a substrate cutout portion 111. The substrate cutout portion 111 is recessed upward from the lower end surface of the housing cylindrical portion 11 and penetrates in the radial direction. For example, the opening shape of the substrate cutout portion 111 as viewed from the radial direction is a substantially rectangular shape. However, the opening shape of the substrate cutout portion 111 as viewed from the radial direction is not particularly limited. As a result, a part of the radially outer surface of the bearing cylindrical portion 21 is exposed from the housing cylindrical portion 11 via the substrate cutout portion 111.

Here, in the first example embodiment, the circuit board 40 is fixed to a portion of the bearing cylindrical portion 21 exposed from the housing cylindrical portion 11 via the substrate cutout portion 111. In other words, at least a part of the circuit board 40 is disposed in the substrate cutout portion 111.

As a result, in the first example embodiment, it is possible to suppress the circuit board 40 from protruding to the radially outer side from the radially outer surface of the housing cylindrical portion 11. That is, the vibration motor 1000 can be prevented from increasing in the radial direction.

In the first example embodiment, the cutting depth of the substrate cutout portion 111 in the axial direction reaches the arrangement region of the coil 3. That is, at least a part of the coil 3 is exposed to the radially outer side from the housing cylindrical portion 11 via the substrate cutout portion 111. A portion of the coil 3 exposed to the radially outer side from the housing cylindrical portion 11 is a connection portion of the lead wire 41. Therefore, the sealing portion 50 (see FIG. 1) is disposed in the substrate cutout portion 111. The sealing portion 50 is disposed at least on the upper side of the substrate cutout portion 111.

Accordingly, in the first example embodiment, since the connection portion between the coil 3 and the lead wire 41 is covered by the sealing portion 50 from the radially outer side, it is possible to suppress the movement of the lead wire 41. As a result, disconnection such as detachment of the lead wire 41 from the coil 3 or detachment of the lead wire 41 from the circuit board 40 can be suppressed.

Although not illustrated, the arrangement region of the sealing portion 50 may be made larger in the axial direction, and the sealing portion 50 may cover at least the solder layer 42 provided at the connection portion between the circuit board 40 and the lead wire 41. Accordingly, it is possible to further suppress the movement of the lead wire 41.

In the first example embodiment, the bearing cylindrical portion 21 has a D-cut surface 210 on the radially outer surface. The D-cut surface 210 is exposed to the radially outer side from the housing cylindrical portion 11 via the substrate cutout portion 111. Therefore, the D-cut surface 210 radially faces a portion of the circuit board 40 arranged in the substrate cutout portion 111. Thus, the circuit board 40 can be fixed to the D-cut surface 210. That is, the circuit board 40 can be fixed to the flat surface. As a result, positional displacement of the circuit board 40 can be suppressed. If the D-cut surface 210 does not exist, the circuit board 40 needs to be arranged on the curved surface, and the fixing of the circuit board 40 becomes unstable. On the other hand, when the circuit board 40 is fixed to the D-cut surface 210 which is a flat surface, the fixing of the circuit board 40 can be further stabilized. For example, the circuit board 40 may be adhered to the D-cut surface 210.

In the first example embodiment, the bearing cylindrical portion 21 includes a positioning portion 212. The positioning portion 212 protrudes to the radially outer side from the D-cut surface 210. The positioning portion 212 is disposed at an upper end of the D-cut surface 210. The lower end surface of the positioning portion 212 is in contact with the upper end portion of the circuit board 40. As a result, the circuit board 40 can be positioned in the axial direction. That is, the circuit board 40 can be prevented from being displaced in the axial direction.

The positioning portion 212 includes a main positioning portion 2121 and a sub positioning portion 2122. The number of main positioning portions 2121 is one. The main positioning portion 2121 is disposed substantially at the center of the D-cut surface 210 in the direction (here, it is referred to as a “width direction”) orthogonal to the axial direction as viewed from the normal direction of the D-cut surface 210. There are two sub positioning portions 2122. The two sub positioning portions 2122 are arranged on one side and the other side in the width direction, respectively.

The presence of the plurality of positioning portions 212 can further suppress the positional displacement of the circuit board 40 in the axial direction. In addition, it is possible to prevent the circuit board 40 from being inclined when viewed from the normal direction of the D-cut surface 210. The sub positioning portion 2122 may be omitted.

In the first example embodiment, the radially outer tip of the positioning portion 212 is located on the radially inner side of the radially outer surface of the housing cylindrical portion 11 (see FIG. 12). As a result, it is possible to position the circuit board 40 in the axial direction without increasing the size of the vibration motor 1000 in the radial direction.

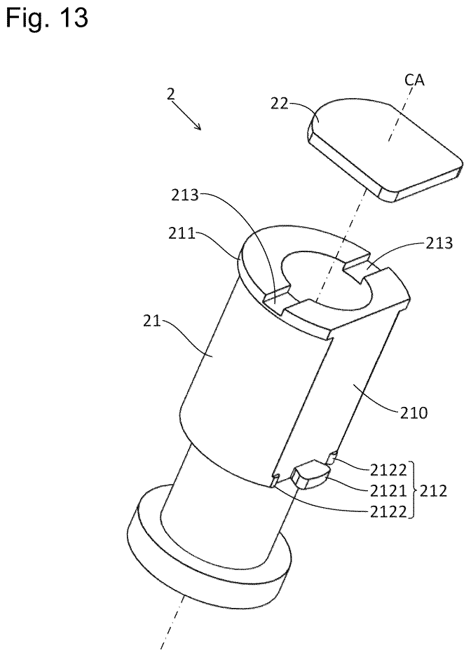

FIG. 13 is a perspective view of the bearing 2 according to the first example embodiment. In FIG. 13, the bearing lid 22 is separated from the bearing cylindrical portion 21. In FIG. 13, the lower end portion of the bearing 2 is illustrated upward.

A part of the core portion 201 is inserted into the bearing cylindrical portion 21 from above. On the other hand, the lower opening of the bearing cylindrical portion 21 is closed by the bearing lid 22. The core portion 201 vibrates in the axial direction in a state where a part thereof is inserted into the bearing cylindrical portion 21. If the air between the bearing lid 22 and the core portion 201 is not released, the damper effect is enhanced and the core portion 201 is less likely to move downward.

Therefore, in the first example embodiment, the lower end surface of the bearing cylindrical portion 21 has an exhaust groove portion 213. The exhaust groove portion 213 is recessed upward and penetrates in the radial direction. The bearing lid 22 is in contact with the lower end surface of the bearing cylindrical portion 21, but is not in contact with the inner surface of the exhaust groove portion 213. That is, a region surrounded by the inner surface of the exhaust groove portion 213 and the bearing lid 22 is a space. As a result, the air inside the bearing cylindrical portion 21 can be released to the outside from the exhaust groove portion 213. As a result, it is possible to suppress the core portion 201 from being difficult to move downward.

The number of the exhaust groove portions 213 is not particularly limited. The number of the exhaust groove portions 213 may be one or plural. For example, there are two exhaust groove portions 213. When the number of the exhaust groove portions 213 is two, it is possible to release the air inside the bearing cylindrical portion 21 to the outside while sufficiently securing the bonding area of the bearing lid 22 with respect to the lower end surface of the bearing cylindrical portion 21.

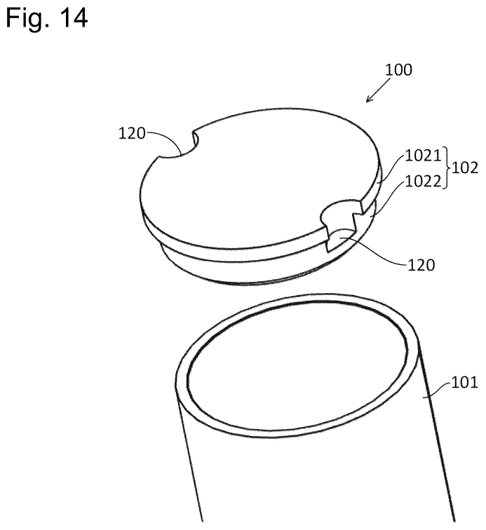

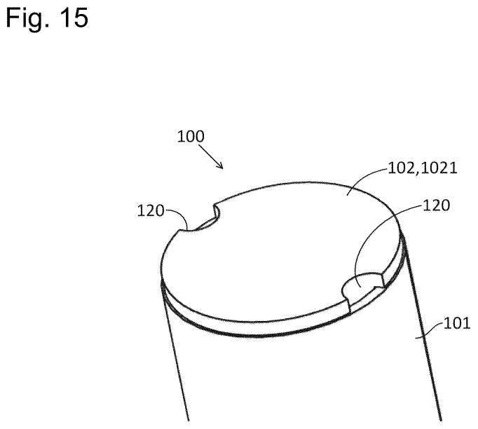

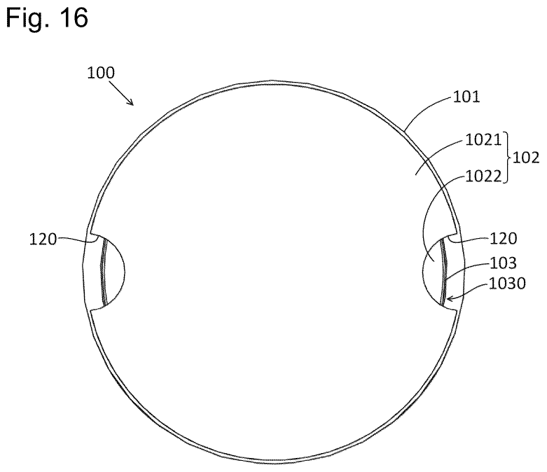

FIG. 14 is an exploded perspective view of a housing 100 according to a second example embodiment, and FIG. 15 is a perspective view of the housing 100 according to the second example embodiment. In other words, FIG. 14 is a view illustrating a state before a housing lid 102 is fixed to a housing cylindrical portion 101, and FIG. 15 is a view illustrating a state after the housing lid 102 is fixed to the housing cylindrical portion 101. In FIGS. 14 and 15, only the periphery of the upper end portion of the housing 100 is illustrated. FIG. 16 is a plan view of the housing 100 according to the second example embodiment as viewed from above.

Next, the second example embodiment will be described. The housing 100 of the second example embodiment is different in configuration from the housing 1 of the first example embodiment. On the other hand, other configurations are common between the second example embodiment and the first example embodiment. Therefore, the description of the first example embodiment is applied to the configuration common between the second example embodiment and the first example embodiment, and the description thereof is omitted here.

The housing 100 of the second example embodiment has a housing cylindrical portion 101 and a housing lid 102. The housing 100 includes an adhesive 103. The housing cylindrical portion 101 has a cylindrical shape extending in the axial direction, and the movable portion 20 (see FIG. 2) is disposed therein. The housing lid 102 is disposed at the upper end portion of the housing cylindrical portion 101.

The housing lid 102 includes a lid body portion 1021 that covers an upper opening of the housing cylindrical portion 101, and a lid fixing portion 1022 that protrudes downward from the lid body portion 1021 and is disposed inside the housing cylindrical portion 101. The adhesive 103 is disposed in at least a part of a bonding region 1030 which is a region between the housing cylindrical portion 101 and the lid fixing portion 1022 in the radial direction.

Accordingly, in the second example embodiment, as in the first example embodiment, the housing lid 102 is fixed to the housing cylindrical portion 101 via the adhesive 103. Here, in the assembly process of the housing 100 of the second example embodiment, similarly to the assembly process of the housing 1 of the first example embodiment, the adhesive 103 is injected into the bonding region 1030 with the dispenser needle. However, in the second example embodiment, an injection port of the adhesive 103 is different from that of the first example embodiment.

In the second example embodiment, the housing lid 102 has a cutout portion 120. Then, the cutout portion 120 serves as an injection port of the adhesive 103. The cutout portion 120 is recessed to the radially inner side from the radially outer surface of the housing lid 102, penetrates the lid body portion 1021 in the axial direction from the upper end surface of the housing lid 102, and reaches the lid fixing portion 1022. As a result, a part of the bonding region 1030 is exposed from the housing cylindrical portion 101 via the cutout portion 120. In other words, a part of the lid fixing portion 1022 is exposed from the housing cylindrical portion 101 via the cutout portion 120. In other words, a part of the bonding region 1030 is exposed to the outside of the housing 100 through the cutout portion 120. As a result, a part of the bonding region 1030 is visible from the outside of the housing 100 (specifically, above the housing 100).

Thus, in the second example embodiment, as in the first example embodiment, in the assembly process of the housing 100, the adhesive 103 can be injected into the bonding region 1030 in a state where the lid fixing portion 1022 is disposed inside the housing cylindrical portion 101. Specifically, in the assembly process of the housing 100, first, the lid fixing portion 1022 is fitted into the housing cylindrical portion 101. Here, even when the lid fixing portion 1022 is fitted into the housing cylindrical portion 101, the bonding region 1030 is exposed from the cutout portion 120. Thereafter, although not illustrated, the tip of the dispenser needle (that is, the discharge port) is disposed in the cutout portion 120, and the adhesive 103 is discharged from the dispenser needle. At this time, the adhesive 103 enters the bonding region 1030 exposed from the cutout portion 120, and the adhesive 103 flows in the circumferential direction. As a result, substantially the entire area of the bonding region 1030 is filled with the adhesive 103. That is, the housing lid 102 is fixed to the housing cylindrical portion 101 via the adhesive 103.

As a result, in the second example embodiment, as in the first example embodiment, the housing lid 102 can be firmly fixed to the housing cylindrical portion 101. That is, it is possible to suppress a decrease in strength of the housing 100. In the assembly process of the housing 100, the wiping operation of the adhesive 103 can be omitted.

Other configurations of the housing 100 of the second example embodiment are similar to the configurations of the housing 1 of the first example embodiment. That is, although not illustrated, the housing cylindrical portion 101 has a substrate cutout portion that is recessed upward from the lower end surface of the housing cylindrical portion 101 and penetrates in the radial direction.

The example embodiments of the present disclosure have been described above. The scope of the present disclosure is not limited to the above-described example embodiments. The present disclosure can be implemented with various modifications within a scope not departing from the gist of the disclosure. The above-described example embodiments can be appropriately and optionally combined.

The present disclosure can have any of the following example configurations (1) to (13).
(1) A vibration motor including: a stationary portion; and a movable portion capable of vibrating the stationary portion in an axial direction along a center axis, in which the stationary portion includes a housing, the housing includes: a housing cylindrical portion that has a cylindrical shape extending in the axial direction along the center axis and in which the movable portion is located; a housing lid located at an end on one side in the axial direction of the housing cylindrical portion; and an adhesive, the housing lid includes: a lid body portion that covers an opening on one side in the axial direction of the housing cylindrical portion; and a lid fixing portion that protrudes from the lid body portion to another side in the axial direction and is located inside the housing cylindrical portion, the adhesive is located in at least a portion of a bonding region that is a region between the housing cylindrical portion and the lid fixing portion in a radial direction, the housing cylindrical portion includes a cutout portion that is recessed from an end surface on one side in the axial direction of the housing cylindrical portion to the other side in the axial direction and penetrates the housing cylindrical portion in the radial direction, and a portion of the bonding region is exposed to an outside of the housing through the cutout portion.
(2) The vibration motor according to (1), in which a radially outer surface of the lid fixing portion extends continuously in a circumferential direction along a radially inner surface of the housing cylindrical portion.
(3) The vibration motor according to (1) or (2), in which a thickness of the lid fixing portion in the axial direction is equal to or more than a half of a cutting depth of the cutout portion in the axial direction.
(4) The vibration motor according to any one of (1) to (3), in which the lid fixing portion closes an entire region of the cutout portion when viewed from the radial direction.
(5) The vibration motor according to any one of (1) to (4), in which an opening width of the cutout portion in a circumferential direction is equal to or less than a half of a length of the housing cylindrical portion in the circumferential direction.
(6) The vibration motor according to any one of (1) to (5), including a circuit board, in which the stationary portion includes a coil that is located inside the housing cylindrical portion and applies a driving force to the movable portion, the circuit board is electrically connected to the coil, the housing cylindrical portion includes a substrate cutout portion that is recessed to one side in the axial direction from an end surface on the other side in the axial direction of the housing cylindrical portion and penetrates the housing cylindrical portion in the radial direction, and at least a portion of the circuit board is located in the substrate cutout portion.
(7) The vibration motor according to (6), including: a lead wire that connects the coil and the circuit board; and a sealing portion, in which a cutting depth of the substrate cutout portion in the axial direction reaches an arrangement region of the coil, and the sealing portion is located in the substrate cutout portion and covers at least a connection portion between the coil and the lead wire from a radially outer side.
(8) The vibration motor according to (6) or (7), in which the movable portion includes a core portion extending in the axial direction along the center axis, the stationary portion includes a bearing that supports the core portion so as to be able to vibrate in the axial direction along the center axis, the bearing includes a bearing cylindrical portion that is located inside the housing cylindrical portion and into which at least a portion of the core portion is inserted, the bearing cylindrical portion has a cylindrical shape extending in the axial direction along the center axis, and includes a D-cut surface on a radially outer surface, and the D-cut surface radially opposes a portion of the circuit board located in the substrate cutout portion.
(9) The vibration motor according to (8), in which the bearing cylindrical portion includes a positioning portion, and the positioning portion protrudes to a radially outer side from the D-cut surface and contacts an end on one side in the axial direction of the circuit board.
(10) The vibration motor according to (9), in which a radially outer tip of the positioning portion is located on a radially inner side of a radially outer surface of the housing cylindrical portion.
(11) The vibration motor according to any one of (1) to (10), in which the movable portion includes a core portion extending in the axial direction along the center axis, the stationary portion includes a bearing that supports the core portion to be able to vibrate in the axial direction along the center axis, the bearing includes: a bearing cylindrical portion which is located inside the housing cylindrical portion and into which at least a portion of the core portion is inserted; and a bearing lid that covers an opening on another side in the axial direction of the bearing cylindrical portion, an end on the other side in the axial direction of the bearing cylindrical portion protrudes from the housing cylindrical portion to the other side in the axial direction, and an end surface on the other side in the axial direction of the bearing cylindrical portion includes an exhaust groove portion that is recessed toward one side in the axial direction and penetrates in the radial direction.
(12) The vibration motor according to any one of (1) to (11), in which a radially outer surface of the lid fixing portion includes an adhesive groove portion that is recessed to a radially inner side and extends in a circumferential direction.
(13) A vibration motor including: a stationary portion; and a movable portion capable of vibrating the stationary portion in an axial direction along a center axis, in which the stationary portion includes a housing, the housing includes: a housing cylindrical portion that has a cylindrical shape extending in the axial direction along the center axis and in which the movable portion is located; a housing lid located at an end on one side in the axial direction of the housing cylindrical portion; and an adhesive, the housing lid includes: a lid body portion that covers an opening on one side in the axial direction of the housing cylindrical portion; and a lid fixing portion that protrudes from the lid body portion to another side in the axial direction and is located inside the housing cylindrical portion, the adhesive is located in at least a portion of a bonding region which is a region between the housing cylindrical portion and the lid fixing portion in a radial direction, the housing lid includes a cutout portion that is recessed to a radially inner side from a radially outer surface of the housing lid, penetrates the lid body portion in the axial direction from an end surface on one side in the axial direction of the housing lid, and reaches the lid fixing portion, and a portion of the bonding region is exposed to the outside of the housing through the cutout portion.

The present disclosure is applicable to, for example, a vibration motor mounted on various devices such as portable devices.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A vibration motor comprising:
a stationary portion; and
a movable portion capable of vibrating the stationary portion in an axial direction along a center axis; wherein
the stationary portion includes a housing;
the housing includes:
a housing cylindrical portion that has a cylindrical shape extending in the axial direction along the center axis and in which the movable portion is located;
a housing lid located at an end on one side in the axial direction of the housing cylindrical portion; and
an adhesive;
the housing lid includes:
a lid body portion that covers an opening on one side in the axial direction of the housing cylindrical portion; and
a lid fixing portion that protrudes from the lid body portion to another side in the axial direction and is located inside the housing cylindrical portion;
the adhesive is located in at least a portion of a bonding region between the housing cylindrical portion and the lid fixing portion in a radial direction;
the housing cylindrical portion includes a cutout portion that is recessed from an end surface on one side in the axial direction of the housing cylindrical portion to the other side in the axial direction and penetrates the housing cylindrical portion in the radial direction; and
a portion of the bonding region is exposed to an outside of the housing through the cutout portion.

2. The vibration motor according to claim 1, wherein a radially outer surface of the lid fixing portion extends continuously in a circumferential direction along a radially inner surface of the housing cylindrical portion.

3. The vibration motor according to claim 1, wherein a thickness of the lid fixing portion in the axial direction is equal to or more than a half of a cutting depth of the cutout portion in the axial direction.

4. The vibration motor according to claim 1, wherein the lid fixing portion closes an entire region of the cutout portion when viewed from the radial direction.

5. The vibration motor according to claim 1, wherein an opening width of the cutout portion in a circumferential direction is equal to or less than a half of a length of the housing cylindrical portion in the circumferential direction.

6. The vibration motor according to claim 1, further comprising a circuit board, wherein
the stationary portion includes a coil that is located inside the housing cylindrical portion and applies a driving force to the movable portion;
the circuit board is electrically connected to the coil, the housing cylindrical portion includes a substrate cutout portion that is recessed to one side in the axial direction from an end surface on the other side in the axial direction of the housing cylindrical portion and penetrates the housing cylindrical portion in the radial direction; and
at least a portion of the circuit board is located in the substrate cutout portion.

7. The vibration motor according to claim 6, further comprising:
a lead wire that connects the coil and the circuit board; and
a sealing portion; wherein
a cutting depth of the substrate cutout portion in the axial direction reaches an arrangement region of the coil; and
the sealing portion is located in the substrate cutout portion and covers at least a connection portion between the coil and the lead wire from a radially outer side.

8. The vibration motor according to claim 6, wherein
the movable portion includes a core portion extending in the axial direction along the center axis;
the stationary portion includes a bearing that supports the core portion to be able to vibrate in the axial direction along the center axis;
the bearing includes a bearing cylindrical portion that is located inside the housing cylindrical portion and into which at least a portion of the core portion is inserted;
the bearing cylindrical portion has a cylindrical shape extending in the axial direction along the center axis, and includes a D-cut surface on a radially outer surface; and
the D-cut surface radially opposes a portion of the circuit board located in the substrate cutout portion.

9. The vibration motor according to claim 8, wherein
the bearing cylindrical portion includes a positioning portion; and
the positioning portion protrudes to a radially outer side from the D-cut surface and is in contact with an end on one side in the axial direction of the circuit board.

10. The vibration motor according to claim 9, wherein a radially outer tip of the positioning portion is located on a radially inner side of a radially outer surface of the housing cylindrical portion.

11. The vibration motor according to claim 1, wherein
the movable portion includes a core portion extending in the axial direction along the center axis;
the stationary portion includes a bearing that supports the core portion to be able to vibrate in the axial direction along the center axis;
the bearing includes:
a bearing cylindrical portion which is located inside the housing cylindrical portion and into which at least a portion of the core portion is inserted; and
a bearing lid that covers an opening on another side in the axial direction of the bearing cylindrical portion;
an end on the other side in the axial direction of the bearing cylindrical portion protrudes from the housing cylindrical portion to the other side in the axial direction; and
an end surface on the other side in the axial direction of the bearing cylindrical portion includes an exhaust groove portion that is recessed toward one side in the axial direction and penetrates in the radial direction.

12. The vibration motor according to claim 1, wherein a radially outer surface of the lid fixing portion includes an adhesive groove portion that is recessed to a radially inner side and extends in a circumferential direction.

13. A vibration motor comprising:
a stationary portion; and
a movable portion capable of vibrating the stationary portion in an axial direction along a center axis; wherein
the stationary portion includes a housing;
the housing includes:
a housing cylindrical portion that has a cylindrical shape extending in the axial direction along the center axis and in which the movable portion is located;
a housing lid located at an end on one side in the axial direction of the housing cylindrical portion; and
an adhesive;
the housing lid includes:
a lid body portion that covers an opening on one side in the axial direction of the housing cylindrical portion; and
a lid fixing portion that protrudes from the lid body portion to another side in the axial direction and is located inside the housing cylindrical portion;
the adhesive is located in at least a portion of a bonding region which is a region between the housing cylindrical portion and the lid fixing portion in a radial direction;
the housing lid includes a cutout portion that is recessed to a radially inner side from a radially outer surface of the housing lid, penetrates the lid body portion in the axial direction from an end surface on one side in the axial direction of the housing lid, and reaches the lid fixing portion; and
a portion of the bonding region is exposed to the outside of the housing through the cutout portion.
